(19) United States
(12) Patent Application Publication
(10) Pub. No.: US 2013/0298869 A1
(43) Pub. Date: Nov. 14, 2013

(54) METHOD FOR OPERATING AN INTERNAL COMBUSTION ENGINE HAVING AT LEAST TWO CYLINDERS

(71) Applicant: GE Jenbacher GmbH & Co OG, Jenbach (AT)

(72) Inventors: Johann HIRZINGER, Koessen (AT); Herbert KOPECEK, Schwaz (AT)

(21) Appl. No.: 13/944,059

(22) Filed: Jul. 17, 2013

Related U.S. Application Data
(63) Continuation of application No. PCT/AT2011/000491, filed on Dec. 12, 2011.

(30) Foreign Application Priority Data
Jan. 18, 2011 (AT) 66/2011

(51) Int. Cl. F02D 41/30

(52) U.S. Cl. CPC F02D 41/30
USPC 123/395

(57) ABSTRACT

The invention relates to a method for operating an internal combustion engine that has at least two cylinders (1), in particular a gas engine. According to said method, the amount of fuel supplied to each of the at least two cylinders (1) is controlled or regulated for the individual cylinders with the aid of a fuel metering device and a cylinder pressure sensor (2) in accordance with a desired performance and/or a desired torque and/or a desired speed of the internal combustion engine.

The invention concerns a method of operating an internal combustion engine having at least two cylinders, in particular a gas engine. The invention further concerns an internal combustion engine for carrying out such a method.

Methods of operating internal combustion engines having a plurality of cylinders are already known. The methods and regulating systems described in the state of the art for operating internal combustion engines (for example DE 196 21 297 C1, EP 1 688 601 A2, DE 10 2006 024 956 B4, and DE 10 2007 000 443 A1) are primarily suitable for engine regulation of smaller Otto-cycle and diesel engines, as are used for example in private automobiles. Therefore the examples referred to therein relate generally to the use of liquid fuels.

The proposed regulating concepts are not suitable for stationary gas engines with engine power levels over 3 MW which are used for example for generating energy as the physically large dimensions of those engines (for example the mixture rails) mean that there is an undesirably long time delay between the regulating signal and the action on the combustion process in the corresponding cylinder. In addition, with the given dimensions, in the case of mixture-supercharged engines, the same pressure does not occur at all cylinders or the pressure cannot be correctly detected because of flow effects.

JP 2005-069097 and EP 2 136 059 A1 each disclose a gas engine having a plurality of cylinders, wherein the cylinder pressure of a cylinder can be ascertained by means of a cylinder pressure sensor.

The object of the invention is to provide a method with which the power of an internal combustion engine, more especially a gas engine, can be precisely and quickly regulated. That applies in particular for the so-called island-type mode of operation in which the gas engine has to react to a fluctuating power demand of the power network to be supplied. That requires fast precise regulation of the power to be delivered by the gas engine.

According to the invention that object is attained in that in dependence on a desired power and/or a desired torque and/or a desired rotary speed of the internal combustion engine the amount of fuel supplied to each of the at least two cylinders is controlled or regulated in cylinder-individual relationship by means of a fuel metering device and a cylinder pressure sensor.

Hereinafter the terms fuel, fuel gas and gas as well as the terms internal combustion engine, gas engine and engine are respectively used synonymously.

In that respect the pressure in each of the cylinders is used as a management value for controlling or regulating the power and/or the torque and/or the rotary speed of the internal combustion engine. In that case the pressure in the combustion chamber is detected by way of cylinder pressure sensors. The work done or the power delivered by the respective cylinder can be calculated from the measured cylinder pressure by way of known thermodynamic relationships. The power is influenced primarily by the amount of fuel (amount of fuel gas) available for the combustion process. The amount of gas necessary to achieve the required power in the next combustion process is calculated from parameters which are known or which are to be detected, like for example pressure in the combustion chamber, pressure and temperature of the applied air, pressure and temperature of the fuel gas involved and rotary speed, and that corresponding amount of fuel or fuel-air mixture is fed to the cylinders of the internal combustion engine by way of suitable introduction devices.

In that arrangement compressed air and fuel, preferably fuel gas, can be respectively fed in separate form to each of the at least two cylinders. It will be appreciated however that pre-mixing can also be effected and a suitable fuel-air mixture can be supplied.

In a further embodiment of the invention this can be such that the cylinders are synchronised in dependence on the respective cylinder pressure, preferably cylinder peak pressure, or values derived therefrom in relation to the power delivered by the cylinders and/or emission levels, preferably NOx-emission levels. Different geometries in the air induction passage and in the gas conduit and also different valve characteristics can lead to unequal combustion processes in the individual cylinders. In that respect it is advantageous for combustion in the individual cylinders to be synchronised in relation to power yield or NOx-emission levels, with suitable means. For that purpose, it is possible to determine from the cylinder pressure signals values like peak pressure or center of combustion which can be used for synchronisation. It would also be possible to derive from those pressure-indicated values for combustion, important parameters like the excess air ratio (lambda) which can then also be used for synchronisation or for general engine management. Cylinder synchronisation can be brought about in that case by way of cylinder-individual control or regulation of the ignition timing and/or the opening duration and/or the fuel supply pressure of the respective fuel introduction device. Preferably the cylinder peak pressure or the cylinder mean pressure or the cylinder-individual air excess ratio ascertained from the cylinder pressure variation can serve as the management value for cylinder synchronisation regulation.

In a preferred embodiment of the invention it can be provided that the amount of fuel fed to each of the at least two cylinders is established by the opening duration and/or by the fuel supply pressure and/or by the opening cross-section of the respective introduction device for the fuel. In that case the amount of fuel and the feed characteristic can be determined by way of the respective opening and closing times of the introduction device of a cylinder. The introduction devices in that case can be in the form of port injection valves, wherein the respective opening duration of such a port injection valve can be ascertained in accordance with the properties of the valve and the operating conditions. The introduction device can be so designed that it can involve substantially only the two positions of completely opened and completely closed.

The amount of fuel or fuel gas which is fed to a gas engine is the primary influencing factor for the power which can be delivered by the gas engine. Gas amount metering at a port injection valve therefore represents a primary regulating member for the power. In that respect the following relationship is of significance:

$${P}_{mech} = \frac{{m}_{gas} \cdot Hu \cdot {η}_{engine}}{\frac{120}{n}}$$

wherein P_{mech} is the delivered power of the internal combustion engine, m_{gas} is the amount of gas required for that purpose for the entire internal combustion engine, Hu is the lower calorific value of the gas, η_{engine} is the efficiency of the internal combustion engine and n is the speed of the internal combustion engine in rpm.

As the amount of gas m_{gas} primarily influences engine power, torque or speed of the internal combustion engine the reference value of the amount of gas injected into the gas engine can be calculated in accordance with the desired reference value in respect of the regulating parameter.

The amount of fuel m_{gas} for a desired power F_{ref} can accordingly be ascertained by the following formula:

$${m}_{gas} = \frac{{P}_{ref} \cdot \frac{120}{n}}{Hu \cdot {η}_{engine}}$$

The calculation involves the lower calorific value Hu of the gas, the engine efficiency η_{engine} and the rotary speed n of the engine. The efficiency η_{engine} of the internal combustion engine can in that case be respectively ascertained by evaluation of the cylinder pressure variation during the last combustion cycle or for example from an engine characteristic curve.

In regard to exhaust gas regulation and ignition regulation the mixture ratio of the fuel-air mixture may not be set to just any value. The mixture ratio (lambda value) must be so set that the emission levels are lower than a defined emission limit and at the same time the combustion misfire limit is not reached. The corresponding lambda value is specified in that case for example by a suitable combustion regulation or by a characteristic curve or table. With the specified lambda value the amount of fuel is ascertained in respect of a corresponding amount of air for the entire engine. In that case a cylinder can receive only a given amount of air. The amount of air which can be introduced into a cylinder is a function of charging pressure and volumetric efficiency.

In the regulating device the amount of cylinder air can be determined by the permanently measured charging pressure and the calculated volumetric efficiency. In dependence on the amount of gas required for a desired power output level, it is then possible to determine a suitable number of cylinders in which the gas can be uniformly distributed. The gas is injected into the active cylinders, that is to say those which are to be supplied with gas, by suitable introduction devices, for example port injection valves. The opening duration of a valve determines how much gas is injected into a cylinder. The opening durations of the valves can be delivered by the regulating device as a control parameter. The actual value of engine power can be determined by detecting the cylinder pressure variation (cylinder pressure indication) or by measuring the electric power in the network parallel mode of operation and can be used by the regulating device as a feedback signal or management value.

In that case it is also possible to use a time-stepped regulating concept. It can preferably be provided that regulation of the amount of fuel per cylinder is effected in a first regulating cycle in the region of between about 2 and 100 combustion cycles, and/or in a second regulating cycle in the region of between about 10 and 1000 combustion cycles regulation is effected by the amount of fuel being adjusted in tracking relationship with the regulated amount of charging air, and/or in a third regulating cycle in the region of between about 100 and 10,000 combustion cycles regulation of the fuel supply pressure is effected per cylinder.

In that way it is possible to define a time succession of regulating interventions, wherein the time durations can be established by way of the number of combustion cycles, over which intervention takes place. The first regulating cycle which is preferably used in the region of between 2 and 100 combustion cycles serves in that case for pure power output regulation and is referred to as the gas-controlled regulating principle. Predetermining the amount of gas represents the primary regulating intervention, in which respect a secondary regulating intervention can be effected by the necessary amount of charging air being adapted in accordance with the amount of gas. Such a regulating intervention is suitable in particular for short-term power output regulation in which highly dynamic interventions (for example cycle-based monitoring procedures and deviations in rotary speed) can be implemented by cycle-synchronous direct interventions in the amount of gas. In addition such a regulating intervention is suitable in particular for rapidly achieving cylinder synchronisation.

Purely short-term power output regulation however suffers from the disadvantage that it is not possible to take account of operating conditions which are altered therewith such as for example an altered gas composition, gases of low calorific value, wear, high outside temperatures and so forth. It is therefore possible to provide further longer-term regulating cycles, by which, besides the possibility of short-term gas-controlled regulation for example to remove short-term disturbances, longer-term regulating interventions are possible in order to maintain a high level of efficiency and/or advantageous emission development.

In a second regulating cycle it can therefore be provided that the amount of charging air is used as the primary regulating intervention and the corresponding amount of fuel is controlled in tracking relationship with the amount of charging air (air-controlled regulating principle). That regulating principle is suitable in particular for power output regulation and for regulating quasi-steady processes such as for example accelerating a gas engine up to its nominal load.

Processes which can be referred to as higher-order steady processes can be controlled in a third regulating cycle by adaptation of the fuel supply pressure (gas pressure-controlled regulating principle), in which respect optimisation processes can in turn be effected by adaptation of the amount of gas with a low demand in respect of time in accordance with the first regulating cycle.

In a particularly preferred embodiment it can be provided that individual cylinders are targetedly shut down by the regulation or control, wherein the cylinders which are not shut down deliver the desired power and/or make available the desired torque and/or the desired rotary speed of the internal combustion engine. It can preferably be provided that individual cylinders are shut down upon a power demand in respect of the internal combustion engine in the region of between 0% and 30% of the nominal power of the internal combustion engine. Power or rotary speed regulation in the part-load situation and idle can be effected in that respect by shutting down or switching on individual cylinders, instead of by means of conventional control members like a throttle flap or blow-off valve. As a result this gives a throttle flap-free mode of operation which thus involves lower losses, and a simpler regulating characteristic for the entire internal combustion engine, more especially in relation to turbocharger regulation. Cylinder shutdown in the event of load shedding can naturally also be effected generally in the entire load range of between 0% and 100% of the nominal power of the internal combustion engine.

In dependence on the currently prevailing load situation it can therefore be provided that individual cylinders are selectively shut down or switched on upon a reduction or increase in the load by more than 25% of the nominal load per combustion cycle. If an internal combustion engine is used for example for power generation sensor values which characterise the network status (for example network voltage, frequency, energy demand profiles of the energy provider) can be used to detect load jumps in advance and to be able to react thereto quickly. If the internal combustion engine is in an island-type mode of operation then measurement values on the part of the electric load can be detected for that purpose (for example consumer demand, wind speed measurements or solar intensity measurements). If the internal combustion engine is used as a drive for for example pumps or compressors measurements for example at an air compressor provided in the internal combustion engine (for example compressor inlet pressure, compressor outlet pressure) can be used to be able to quickly determine load switch-on or shut-down phenomena or also short load surges. Torque and/or rotary speed measurements can also be used to detect changes in load.

In the event of a load being switched on individual cylinders or also all cylinders can be supplied during the transient phase with an enriched fuel-air mixture by means of the individual gas injection in order temporarily to provide more power to an exhaust gas turbocharger in the internal combustion engine and thus to be able to more quickly overcome the known turbolag effect. In that respect the ignition timing can also be moved at the same time to avoid knocking.

The possibility of controlling or preventing the supply with fuel gas in cylinder-individual relationship can also be used to temporarily switch off the gas (for example for between one and two combustion cycles) to detect the pure compression curve and to be able to detect therefrom possible valve damage or wear, for example of an inlet and/or exhaust valve of a cylinder. It can therefore be provided that for functional monitoring of a cylinder the fuel supply is shut down for one or more combustion cycles, preferably between one and two combustion cycles, and the variation of the cylinder pressure in time occurring in that situation is ascertained. A phase without combustion can also be used to harmonise the cylinder pressure sensors. Such a harmonisation operation may be necessary to be able to calculate parameters like for example the center of combustion with sufficient accuracy from the cylinder pressure signals. Valve wear or deposits which lead to a change in the compression ratio can also be detected by way of determining the pump mean pressure or corresponding pumping losses during such a phase. If in that case the values of a plurality of sensors are compared together then inter alia sensor defects can be distinguished from a genuine malfunction of the internal combustion engine.

A particular advantageous embodiment of the invention is that in which the respective combustion processes of the at least two cylinders are monitored by a cylinder sensor means, preferably cylinder pressure indication means. The so-called cylinder pressure indication serves to detect the internal pressure prevailing in the cylinder in dependence on crankshaft angle or time. Particularly in conjunction with further measurement values like for example the exhaust gas temperature at the cylinder outlet or the torque it is possible to ascertain whether combustion in a cylinder actually differs from the other cylinders or whether for example the cylinder pressure sensor of the cylinder in question is defective. In addition, by means of cylinder pressure indication, it is possible to implement monitoring of cycle-based limits in respect of combustion processes like for example knocking or a misfire as well as optimisation over a plurality of cycles and monitoring of and reaction to fluctuating gas quality. It is possible for that purpose to use a value ascertained from the cylinder pressure, by calculation, like for example the center of combustion and the mean pressure.

It can further be provided that the at least two cylinders are operated with different fuels. In that case for example individual cylinders can be operated with diesel. Such a hybrid mode of operation can be advantageous in order to be able to better dynamically regulate the turbine power and thus the charging effect as required with the diesel-operated cylinders by virtue of their wider combustion window. The gas-operated cylinders in that case operate substantially constantly and are only used for example for slow regulating interventions (for example NOx regulation).

The object of the invention is also attained by an internal combustion engine having the features of claim 14. Advantageous developments of that internal combustion engine are set forth by the claims appended thereto.

Further details and advantages of the present invention are described more fully hereinafter by means of the specific description with reference to the embodiments by way of example shown in the drawings in which:

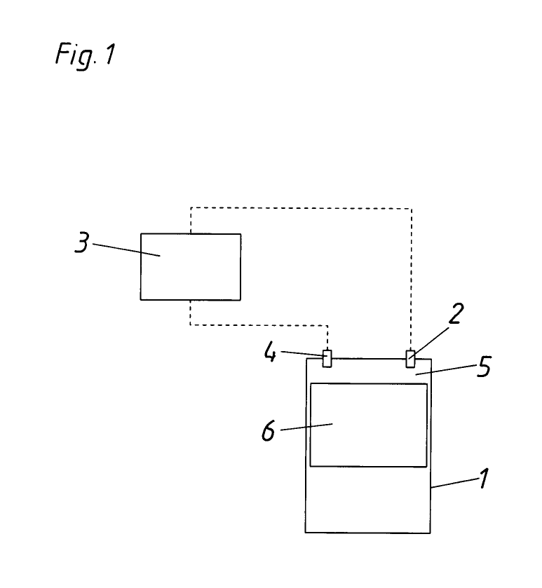

FIG. 1 shows a diagrammatic view of a cylinder with introduction device and cylinder pressure sensor, and

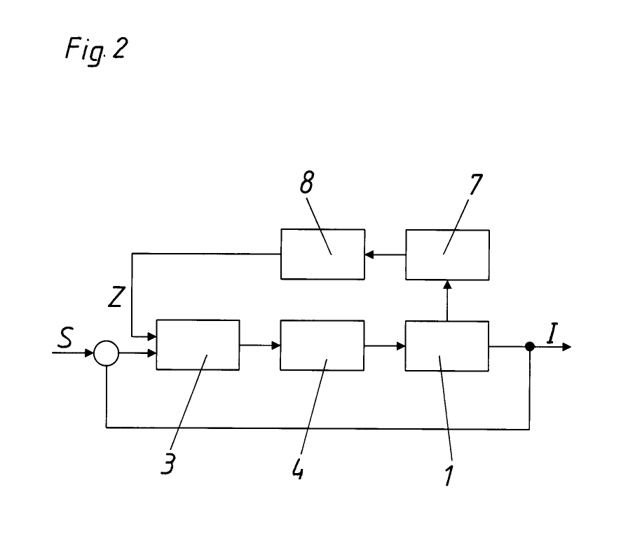

FIG. 2 shows a diagrammatic block circuit diagram of a proposed regulating concept.

FIG. 1 diagrammatically shows a cylinder 1 of an internal combustion engine 9 with a piston 6 disposed therein. In that arrangement an introduction device 4 serves for injecting fuel gas into the combustion chamber 5. A cylinder pressure sensor 2 supplies for example continuously or in time-discrete relationship and/or in dependence on the angle of a crankshaft (not shown here) connected to the piston 6, corresponding measurement data of the pressure in the combustion chamber 5 of the cylinder 1 to a control or regulating device 3 which serves for controlling or regulating power and/or torque and/or rotary speed of the internal combustion engine 9. In dependence on the desired regulating value the control or regulating device 3 provides for metering a suitable amount of fuel for the cylinder 1 and injecting it into the combustion chamber 5 by means of the introduction device 4. In this example therefore the control or regulating device 3 together with the introduction device 4 performs the function of a fuel metering device.

FIG. 2 shows a diagrammatic block circuit diagram of a proposed gas-controlled regulating concept using a control or regulating device 3 for regulating the amount of fuel for a cylinder 1 in dependence on the desired reference value S.

In this case the reference value S and the actual value I can be the engine power, the torque or for example the rotary speed. In the cylinder 1 the cylinder pressure variation is detected by at least one cylinder pressure sensor 2 (not shown here) and evaluated by a cylinder pressure indication device 7. The cylinder pressure can be detected by such a cylinder pressure indication device in dependence on time and/or the angle of a crankshaft (not shown here) connected to the piston 6 of the cylinder 1. Based on the cylinder pressure variation which is afforded by the cylinder pressure indication device 7 to an evaluation device 8 relevant parameters such as for example engine power, engine efficiency, volumetric efficiency, currently prevailing lambda value and cylinder peak pressure can be ascertained by the evaluation device 8. One or more of those ascertained additional data Z can be passed to the control or regulating device 3 in order for example to determine the number of cylinders to be supplied with fuel and the opening durations of the introduction devices 4 (for example port injection valves). The correspondingly required amount of fuel can then be injected into the respective cylinder 1 by the introduction device 4.

1. A method of operating an internal combustion engine having at least two cylinders, in particular a gas engine, wherein in dependence on a desired power and/or a desired torque and/or a desired rotary speed of the internal combustion engine the amount of fuel supplied to each of the at least two cylinders is controlled or regulated in cylinder-individual relationship by means of a fuel metering device and a cylinder pressure sensor.

2. A method as set forth in claim 1 wherein compressed air and fuel, preferably fuel gas, are respectively supplied in separate form to each of the at least two cylinders.

3. A method as set forth in claim 1 wherein the pressure in each of the cylinders is used as a management value for controlling or regulating the power and/or the torque and/or the rotary speed of the internal combustion engine.

4. A method as set forth in claim 1 wherein the amount of fuel fed to each of the at least two cylinders is established by the opening duration and/or by the fuel supply pressure and/or by the opening cross-section of the respective introduction device for the fuel.

5. A method as set forth in claim 1 wherein a cylinder synchronisation is brought about by way of cylinder-individual control or regulation of the ignition time and/or the opening duration and/or the fuel supply pressure of the respective introduction device for the fuel, wherein preferably the cylinders are synchronised in dependence on the respective cylinder pressure, preferably cylinder peak pressure, or values derived therefrom in relation to the power delivered by the cylinders and/or emission levels, preferably NOx-emission levels.

6. A method as set forth in claim 1 wherein
regulation of the amount of fuel per cylinder is effected in a first regulating cycle in the region of between about 2 and 100 combustion cycles, and/or
in a second regulating cycle in the region of between about 10 and 1000 combustion cycles regulation is effected by the amount of fuel being adjusted in tracking relationship with the regulated amount of charging air, and/or
in a third regulating cycle in the region of between about 100 and 10,000 combustion cycles regulation of the fuel supply pressure is effected per cylinder.

7. A method as set forth in claim 1 wherein individual cylinders are targetedly shut down by the control, wherein the cylinders which are not shut down deliver the desired power and/or make available the desired torque and/or the desired rotary speed of the internal combustion engine.

8. A method as set forth in claim 7 wherein individual cylinders are shut down upon a power demand in respect of the internal combustion engine in the region of between 0% and 30% of the nominal power of the internal combustion engine.

9. A method as set forth in claim 7 wherein individual cylinders are selectively shut down or switched on upon a reduction or increase in the load by more than 25% of the nominal load per combustion cycle.

10. A method as set forth in claim 1 wherein for functional monitoring of a cylinder the fuel supply is shut down for one or more combustion cycles, preferably between one and two combustion cycles, and the variation of the cylinder pressure in time occurring in that situation is ascertained.

11. A method as set forth in claim 1 wherein for functional monitoring of a valve of a cylinder the fuel supply is shut down for one or more combustion cycles, preferably between one and two combustion cycles, wherein the compression curve is detected and possible valve damage or valve wear is detected therefrom.

12. A method as set forth in claim 1 wherein the respective combustion processes of the at least two cylinders are monitored by a cylinder sensor means, preferably cylinder pressure indication means.

13. A method as set forth in claim 1 wherein the at least two cylinders are operated with different fuels.

14. An internal combustion engine, in particular a stationary gas engine, comprising
at least two cylinders,
at least one introduction device per cylinder for introducing fuel or a fuel/air mixture into the cylinder, wherein preferably the at least one introduction device for each cylinder is in the form of a port injection device.
a control or regulating device for controlling or regulating at least one of the following values of the internal combustion engine: power, torque, rotary speed,
wherein provided for each cylinder is at least one cylinder pressure sensor whose signals can be fed to the control or regulating device, wherein each of the at least one introduction devices per cylinder is actuable by the control or regulating device for controlling or regulating the desired value, wherein the internal combustion engine is designed without a throttle flap, with at least one turbocharger compressor bypass and/or at least one turbocharger turbine wastegate and/or a variable valve control means and/or a variable turbine geometry and/or a variable compressor geometry.

15. An internal combustion engine as set forth in claim 14 wherein there is provided an air compressor communicating with the at least two cylinders.
